(19) United States
(12) Patent Application Publication
(10) Pub. No.: US 2007/0017551 A1
(43) Pub. Date: Jan. 25, 2007

(54) Dishwasher fill control

(76) Inventor: Daniel G. Hartogh, Delavan, WI (US)

Correspondence Address: JANSSON, SHUPE, MUNGER & ANTARAMIAN, LTD, 245 MAIN STREET, RACINE, WI, 53403, US

(21) Appl. No.: 11/186,099

(22) Filed: Jul. 21, 2005

(51) Int. Cl. B08B 7/04; B08B 9/20

(52) U.S. Cl. 134/18; 134/25.2

(57) ABSTRACT

A method of filling a dishwasher includes inputting first water into a dishwasher in a first fill, monitoring temperature of the first water, pumping the first water out of the dishwasher until the temperature of the first water reaches a first predetermined temperature, then filling the dishwasher with second water in a second fill. The method may use criteria other than temperature for stopping the pumping out of the first water and commencing with the filling of the second fill. Such criteria may include elapsing of a timeout.

### FIELD OF THE INVENTION

The invention relates generally to methods and apparatus for water washing of dishes and the like and, more particularly, to a system for optimizing such washing according to a particular installation.

### BACKGROUND

A dishwasher as a household appliance receives a hot water supply from a hot water heater located in a different location in a home. Depending on the distance from the hot water heater to the dishwasher, the insulation of hot water pipes and their proximity to a cold outside wall, calcification inside pipes, water pressure, and other reasons, the temperature of the hot water may vary at the dishwasher location. For example, the temperature of the hot water line entering the dishwasher may be less than a desired temperature when the dishwasher first begins a fill operation. When the distance between the hot water heater is large, it may take a relatively long period of time for the hot water to reach such desired temperature.

It is an object of the invention to provide an improved dishwashing method overcoming some of the problems and shortcomings of the prior art, including those referred to above.

### SUMMARY

According to a first aspect of the invention, a method includes inputting first water into a dishwasher in a first fill, monitoring temperature of the first water, pumping the first water out of the dishwasher until the temperature of the first water reaches a first predetermined temperature, and then filling the dishwasher with second water in a second fill.

According to another aspect of the invention, a method includes inputting water into a dishwasher, pumping the water out of the dishwasher until a predetermined amount of time has elapsed, and then filling the dishwasher with water.

According to an additional aspect of the invention, a dishwasher includes a hot water inlet, a temperature sensor for measuring a temperature of water being input via the hot water inlet, a wash starter that initiates a dish washing when the water being input reaches a predetermined fill level, and means for pumping the water being input out of the dishwasher, thereby preventing the water being input from reaching the fill level, until a specified criteria is met.

As a result of implementing the invention, conventional problems associated with filling a dishwasher with hot water are avoided or reduced.

The foregoing summary does not limit the invention, which is instead defined by the attached claims.

### BRIEF DESCRIPTION OF THE DRAWING FIGURES

FIG. 1 is a perspective view of a dishwasher used in an exemplary embodiment of the invention.

FIG. 2 is a front plan view of a control console used in an exemplary embodiment of the invention.

FIG. 3 is a schematic diagram of an electrical circuit used in an exemplary embodiment of the invention.

FIG. 4 is a flowchart for an exemplary dishwasher filling method that includes purging cold water before the first fill of a cycle, according to an exemplary embodiment of the invention.

FIG. 5 is a flowchart for an exemplary dishwasher filling method that includes purging cold water before each fill during a cycle, according to an exemplary embodiment of the invention.

FIG. 6 is a flowchart for an exemplary dishwasher filling method that includes testing the temperature of a hot water supply during each fill of a cycle, according to an exemplary embodiment of the invention.

FIG. 7 is a flowchart for an exemplary dishwasher filling method that includes testing the hot water supply temperature before each fill and illuminating a test indicator during such temperature test, according to an exemplary embodiment of the invention.

FIGS. 8A and 8B show a flowchart for an exemplary dishwasher filling method that includes testing the hot water supply temperature before each fill, illuminating a test indicator during such temperature test, and flashing the test indicator and displaying the incorrect temperature when the temperature is outside a predetermined range, according to an exemplary embodiment of the invention.

FIG. 9 shows a flowchart for an exemplary dishwasher filling method that may be used as an alternative to the method of FIG. 8A, according to an exemplary embodiment of the invention.

### DETAILED DESCRIPTION OF PREFERRED EMBODIMENTS

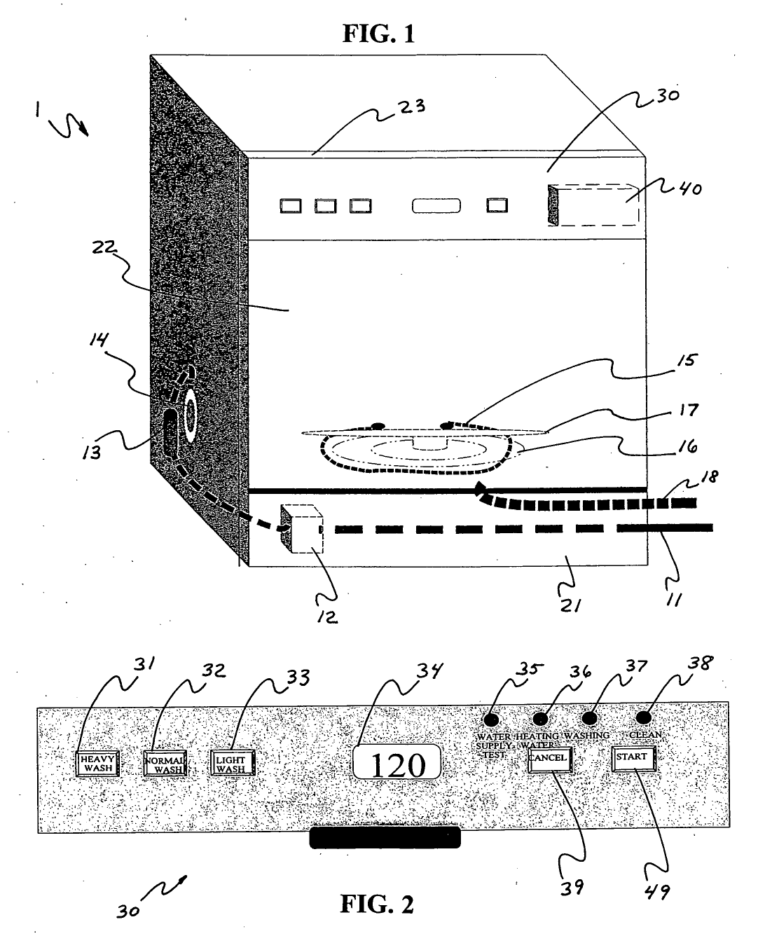

FIG. 1 shows a dishwasher 1 of a general type used in the kitchen of a typical home. Dishwasher 1 includes connection apparatus (not shown) for receiving a hot water supply line 11 from a remote hot water heater (not shown). Hot water supply line 11 is fed to a water control valve 12 located in a bottom portion 21 of dishwasher 1. Water control valve 12 is an actively-controlled valve that opens to allow hot water from hot water supply line 11 to be fed to tub water inlet 14 via water supply temperature sensor 13, and closes to shut off such hot water flow. Water control valve 12 is preferably an electro-mechanical valve, although it may alternatively be controlled hydraulically, pneumatically, mechanically, or by similar active control. The hot water is input to the interior portion 22 of dishwasher 1. A heat element 15 is located in a lower part of interior portion 22, so that water may be further heated inside dishwasher 1, or for providing heat during a drying period. A pump and motor assembly 16 is also located in a lower part of interior portion 22. A rotating spray head 17 is connected to the motor for rotatably distributing water within interior portion 22. The pump is configured for inputting water at the lower part of interior portion 22 and propelling such water out of dishwasher 1 via drain line 18.

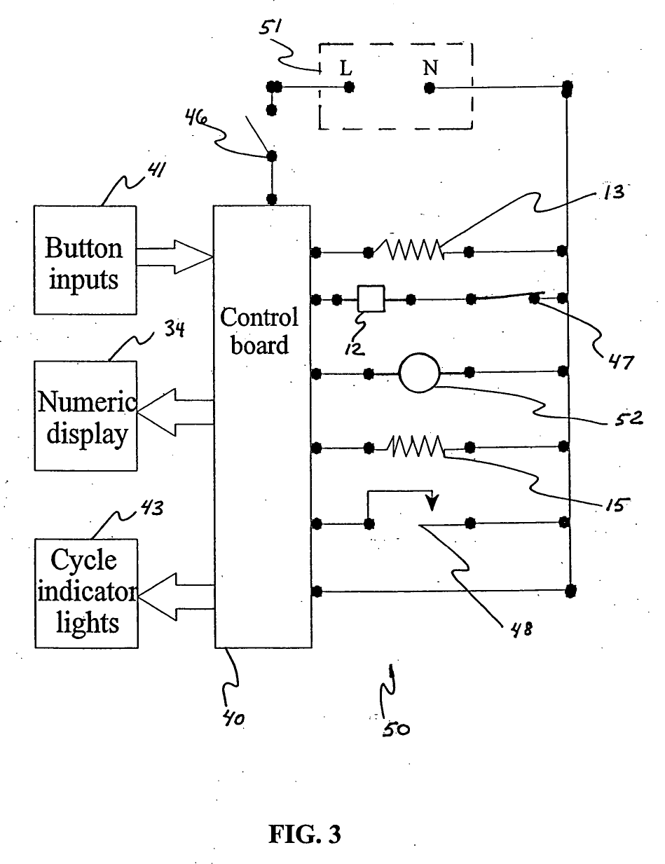

A control console 30 is located on a front face 23 of dishwasher 1 and provides a user interface that displays information to a user and that receives control inputs from the user. As shown in FIG. 2, button inputs include a button group for selecting a type of wash, the group including heavy wash button 31, normal wash button 32, and light wash button 33. Each one of buttons 31, 32, 33 selects a different series of washing operations. Such series of operations are controlled by a control board 40. Some of the various operations currently being performed during a wash include providing a status indication to the user. For example, a water supply test is shown by illuminating front panel indicator 35, a water heating operation is shown by illuminating front panel indicator 36, a washing operation is shown by illuminating front panel indicator 37, and the completion of the wash cycle is shown by illuminating front panel indicator 38. The “CLEAN” light 38 is turned off at the first door opening. Other operations, such as scrub operations may alternatively be shown. In other embodiments, operations such as time delays may effect a separate status indication, such as a “WAIT” light. A start button 49 initiates the particular type of wash selected, and a cancel button 39 resets the wash program.

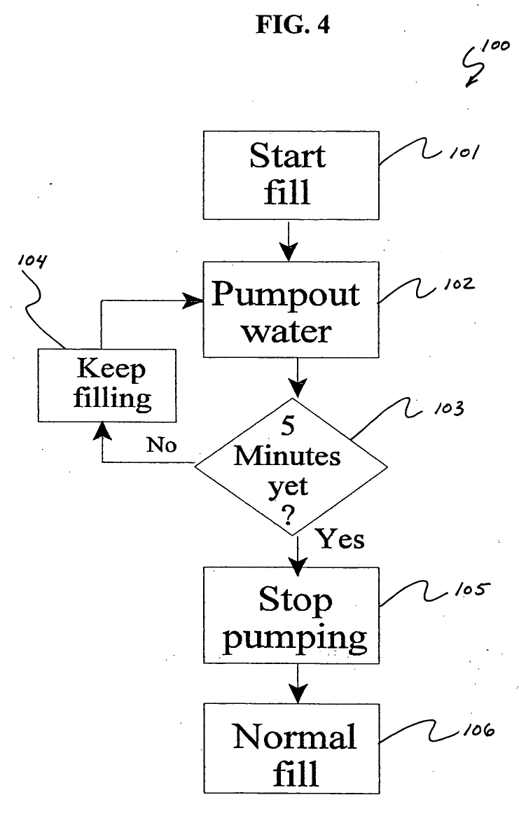

FIG. 3 is a schematic diagram of an electrical circuit 50 used in an exemplary embodiment. As shown, a door switch 46 may be implemented as a mechanism for a series disconnection of electric power to control board 40 and, as a result, for a series disconnection of electric power to all powered assemblies of dishwasher 1. In other embodiments, door switch 46 may be used for disconnecting electric power only to selected sections of circuit 50. The electric power to dishwasher 1 is supplied from a single phase line input, for example 120 VAC, at a service connection 51. Control board 40 receives a user input via user buttons 41, which may include, for example, any of buttons 31, 32, 33, 39, 49. A water supply temperature sensor 13 provides to control board 40 an electrical quantity such as a current, representing the temperature being sensed by temperature sensor 13. Control board 40 preferably has an array logic device that may include a microprocessor or the like for converting the temperature signal from sensor 13 to a Fahrenheit temperature signal that is fed to a numeric display 34 located on the face of control console 30. Such a microprocessor may be a Programmed Integrated Circuit (PIC) available from Microchip Technology, Inc. Numeric display 34 has a three digit temperature display and may optionally be structured for also displaying other information to a user, such as messages and the like. A hot water inlet valve 12 is controlled by control board 40 for opening/closing a fluid path between hot water supply line 11 and hot water inlet 14. Any suitable controllable valve type may be used including, for example, those requiring ancillary apparatus and those configured as multiple individual valves. In the embodiment shown, a safety float switch 47 is connected in the same electrical branch as hot water inlet valve 14. In operation, safety float switch acts to open the electrical circuit when a water level in an interior portion 22 reaches a predetermined level. Such provides a redundant safety switch for stopping hot water from being input when a fill amount reaches a particular water level. Safety float switch 47 may optionally also effect a shutoff of other valve(s) (not shown), effect the start of operation of a drain pump, or trigger/stop any other suitable operation of dishwasher 1, by separate switch detection input to control board 40.

Pump and wash motor assembly 52 may have a drain impeller and a wash impeller each connected to a shaft of a motor. Such a motor may be a reversing motor that operates the drain impeller in one direction of rotation and that operates the wash impeller in the other shaft rotation direction. Reversal of motor direction Alternatively, separate drive mechanisms may be provided for a drain pump and for a wash pump. The wash impeller supplies hot water to rotating spray head 17. Heating element 15 is activated by control board 40 for increasing the temperature of hot water in the sump area of interior portion 22, such as during a “pots-n-pans” operation, or for providing heat to interior portion 22 for assisting in drying washed dishes after water has been pumped from interior portion 22. A thermostat 48 may be used for regulating on/off periods of heating element 15 during such drying cycles. Additional thermal sensor(s) or thermal switches (not shown) may be used for controlling operation of heating element 15.

During operation, control console 30 in cooperation with control board 40 effects an illumination of indicator light 35 during temperature testing of hot water being input via temperature sensor 13. The current temperature from such testing may be displayed on temperature display 34, which may also optionally display a message such as “Incoming Temp.” After a predetermined amount of hot water has been input and such water is not hot enough for use in a given operation, heating element 15 is activated to heat water contained in the sump area of interior portion 22. During such heating, indicator light 36 is illuminated to inform the user of the current performance of a heating operation. During performance of the various wash and rinse operations of a selected wash cycle, an indicator light 37 is illuminated to inform the user that the cycle is in process. When the cycle has been completed and door switch 46 has not yet been opened, an indicator light 38 is illuminated to inform the user that he may now open the door and remove dishes or let the dishes cool. In a given embodiment, light 37 may remain illuminated for a period of time after completion of the actual operations of a cycle, to assure that the “Clean” light 38 is not illuminated until the dishes have cooled, dried, etc.

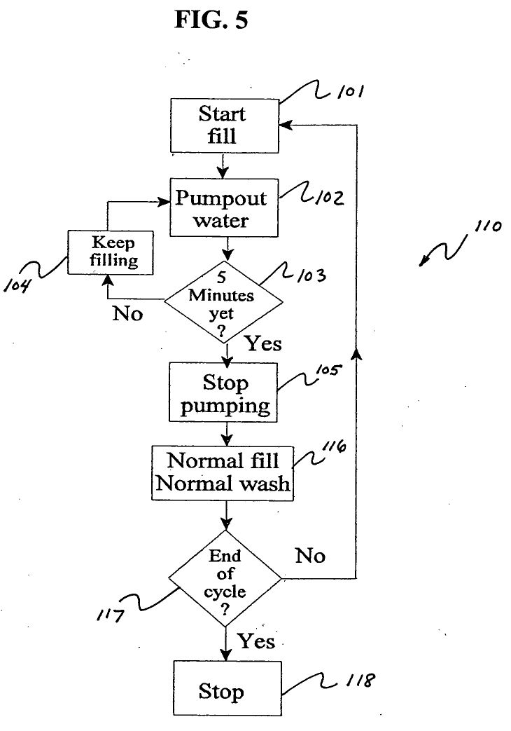

FIG. 4 is a flowchart for an exemplary method 100 for purging cold water before the first fill of a cycle. A user selects a wash cycle to be performed by pressing one button of buttons 31, 32, 33, and then starts the selected cycle by pressing start button 49. Control board 40 receives the input selection and start control and initiates the start of a fill operation at step 101, by opening hot water control valve 12, which allows hot water to flow through water inlet 14 into interior portion 22 via water temperature sensor 13. At step 102, control board 40 causes the drain impeller/pump of pump/wash motor assembly 52 to pump the water from interior portion 22 into drain line 18. At step 103, control board 40 determines whether five minutes has elapsed since the beginning of step 101. If not, the method proceeds to step 103 wherein the drain impeller/pump of pump and wash motor assembly 52 pumps the hot water out of the sump area of interior portion 22 into drain line 18. Although this example uses a five minute pump period, other periods may alternatively be used. When five minutes, or other chosen period, has elapsed, control board 40 stops the drain impeller/pump at step 105 such as by stopping rotation of the motor of pump/motor assembly 52 in the draining direction. Method 100 then proceeds at step 106 to allow the hot water filling to continue for a predetermined time, or until a water level sensor (not shown) indicates that the desired water level has been reached.

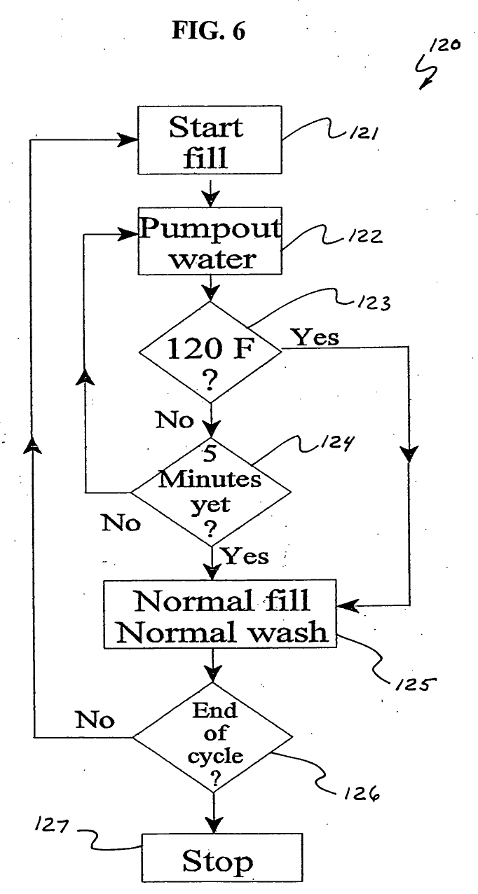

FIG. 5 is a flowchart for an exemplary method 110 for purging cold water before each fill during a cycle. In method 110, steps 101 through 105 are the same as in method 100. Step 116 includes filling the sump area of interior portion 22 before or during a wash operation where the motor of pump/motor section 52 is rotated to cause the hot water in the sump area to be fed through rotating spray head 17 via the wash impeller. Step 116 may include heating the water in the sump area using heating element 15 to raise the water temperature for a given wash operation. As used herein, the term “wash” may include an application of detergent/soap or may include a rinse intended to remove such detergent/soap. Step 116 may include any number of individual wash operations. During or after completion of step 116, a step 117 includes determining whether all operations of the chosen cycle have been completed. If not, control board 40 returns the process to step 101; if all operations of the selected cycle have been performed, then method 110 proceeds to a stop routine at step 118. Such stop routine may include powering the drain impeller/pump to pump water from interior portion 22 into drain line 18, additional rinsing, heat cycles for drying, cool off period(s), etc. At the completion of step 118, indicator light 38 is illuminated.

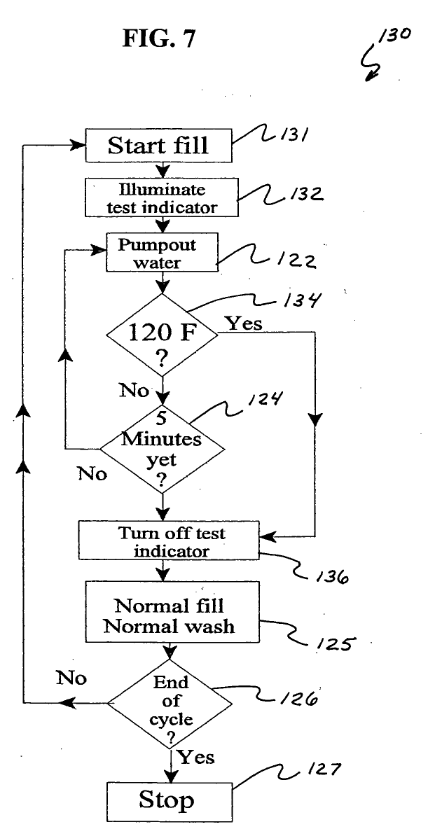

FIG. 6 is a flowchart for an exemplary method 120 that includes testing the temperature of a hot water supply during each fill of a cycle. Steps 121 and 122 are essentially the same as steps 101, 102 described above. Step 123 includes determining whether the temperature at hot water supply temperature sensor 13 is at least one hundred twenty degrees. If so, method 120 proceeds to step 125 where the pumping of step 122 is stopped and where a normal fill and wash are performed in a manner essentially the same as that described above for step 116; if not, then method 120 proceeds to step 124 where a time based apparatus determines whether five minutes has elapsed since the start of the fill. If not, then method 120 continues to pump the water out of the sump area of interior portion 22; if so, then method 120 proceeds to step 125, where filling is completed and a wash operation may be performed essentially in the same manner as described above for step 116. The temperature threshold of step 123 may alternatively be set to any desired temperature other than one hundred twenty degrees. During or after the filling and washing of step 126, a step 126 determines whether all operations of the selected cycle have been performed. If not, method 120 proceeds to pump the water out of the interior portion 22, starts filling the interior portion 22 by the operations of steps 121-124, and then performs another fill and wash as described for step 125. Any of steps 121-125 may have different operational parameters for second or other subsequent repetitions of their respective individual operations. For example, a second pass through the steps 121-125 may change a wash, rinse, or heating duration at step 125, and/or any respective parameter of another step. When step 126 determines that all operations of the cycle have been performed, method 120 proceeds to a stop routine at step 127, which may be essentially the same as step 118 described above.

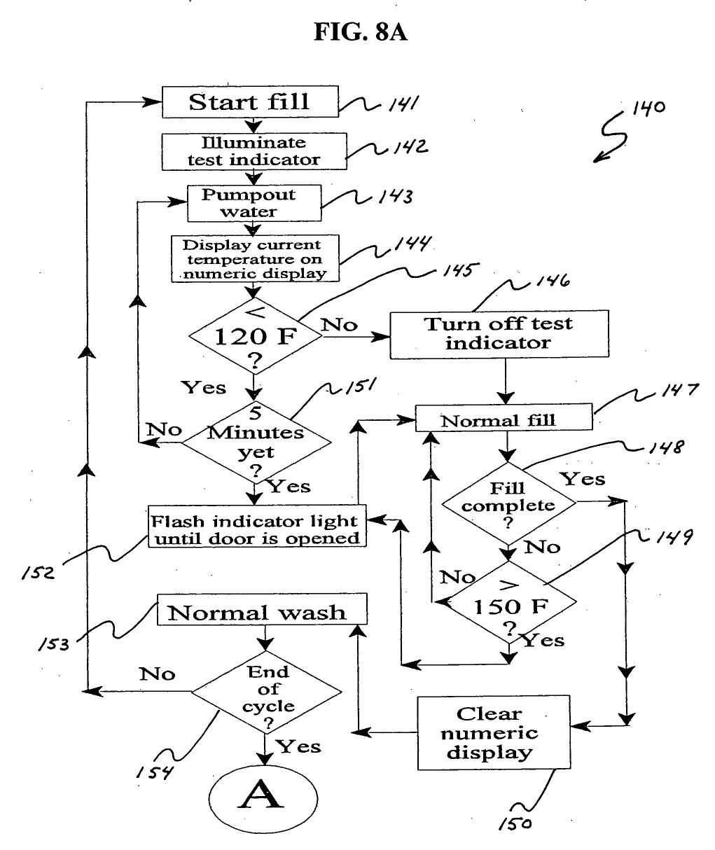

FIG. 7 is a flowchart for an exemplary method 130 that includes testing the hot water supply temperature before each fill and illuminating a test indicator during such temperature test. Method 130 essentially replicates method 120 except that at the start of filling by the opening of hot water control valve at step 131, water supply test indicator 36 is illuminated to inform a user that the temperature of the incoming hot water is currently being measured by hot water supply temperature sensor 13. Accordingly, such temperature measuring by sensor 13 is preferably performed at all times prior to the normal wash and fill step 125. The current temperature is displayed on temperature display 34. Step 122 includes pumping the water out of interior portion 22 until the temperature at sensor 13 reaches one hundred twenty degrees or some other predetermined threshold temperature. When either condition of steps 134 or 124 are met, indicator light 35 is turned off by control board 40. In another embodiment, when test indicator 35 is otherwise on, test indicator 35 is flashed on and off when the current temperature is less than one hundred twenty or more than one hundred fifty degrees. Other settings may be used for such flashing function.

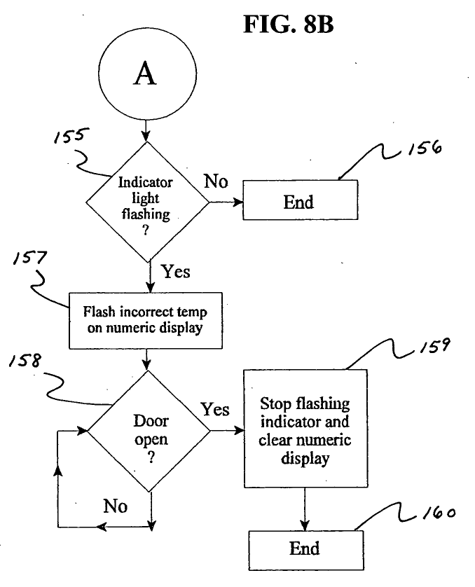

FIGS. 8A and 8B show a flowchart for an exemplary method 140 that includes testing the hot water supply temperature before each fill, illuminating a test indicator during such temperature test, and flashing the test indicator and displaying the incorrect temperature when the temperature is outside a predetermined range. A fill start is performed at step 141, illumination of test indicator 35 at step 142 and pumping out of the hot water from interior portion 22 at step 143, in essentially the same manner as described above for respective steps 131, 132, 122. Step 144 includes displaying the current hot water input temperature continuously until the current filling has been completed. Step 145 includes determining whether the current temperature is less than a predetermined value, for example one hundred twenty degrees Fahrenheit. If so, a step 151 determines whether a time period, for example five minutes, has elapsed and, if the period has not elapsed, allows the pumping of water out of interior portion 22 to continue, and loops method 140 back through the operations of steps 143-145; if the current temperature is not less than the predetermined minimum temperature, method 140 performs step 146 that includes turning off test indicator 35. If step 146 is performed, then method 140 proceeds to step 147 where a predetermined filling operation is performed. If both respective conditions of steps 145, 151 are met, then method 140 at step 152 flashes one or more indicator light(s) until the dishwasher door and door switch 46 are opened. When step 147 is performed, step 148 includes determining whether the filling operation has been completed, such as by passage of a time, sensing a fluid level, etc. During the filling of step 147, the temperature at temperature sensor 13 or at some other location is measured and a step 149 determines whether such temperature exceeds a predetermined value. If not, then method 140 loops back to again perform steps 147-149; if so, then step 152 is performed where one or more indicator light(s) are flashed until door switch 46 is opened. Such flashing of indicator lights may, for example, include simultaneously flashing all of lights 35, 36, 37, 38 and may also include, for example, displaying a text message on temperature display 34. When step 148 determines that a filling is complete, step 150 clears the numeric temperature display 34 and then method 140 performs a predetermined wash operation at step 153. Step 153 may also include illuminating indicator light 37. Step 154 determines whether all operations of the selected cycle have been performed and, if not, method 140 loops back to step 141. If step 154 determines that the cycle is complete, then step 155determines whether an indicator light is flashing: if not, the cycle is ended and indicator light 38 is illuminated; if so, then the current out-of-range temperature is displayed on display 34 in a step 157. At this time, step 158 determines whether door switch 46 is opened and continuously monitors for such an opening. When door switch is opened, step 159 stops the indicator light(s) from flashing and clears numeric display 34. Finally, when display 34 is cleared, the cycle is ended at step 160. Step 160 may include an indication that the cycle included an out-of-range temperature sensing, such as by providing a text message on temperature display 34.

By implementing any of the various methods, the safest and hottest tap water is made available for the start of a dishwasher cycle. Dishwasher manufacturers recommend the use of the hottest tap water available for achieving the highest cleanliness. Such also achieves shorter wash cycles. Dishwasher detergent manufacturers also recommend using the hottest tap water available. The present inventor has determined that pumping the incoming hot water back out of a dishwasher solves conventional problems related to the temperature of the water for filling. For example, instead of having to run tap water at the sink to ensure that the water being provided to the dishwasher is hot enough, the present methods perform such a task automatically. When an elevated temperature is required by a selected cycle, a thermal input is performed by energizing a heating element. Such thermal inputs during a dishwasher cycle may be performed during a thermal hold wherein the cycle of operation is interrupted while a heater is energized until a thermostat is satisfied or a maximum default time limit elapses. In such a case, the energy is reduced by use of the present method.

Temperature sensor 13 is a thermistor or other temperature sensing device placed in line with the hot water fill tube. A microprocessor or other circuit determines the incoming hot water temperature. When the temperature is below 120 degrees Fahrenheit, or other predetermined temperature set in a program such as by being programmable by a technician, the dishwasher pumps the filling water out via the drain. When the incoming hot water temperature reaches the predetermined value, the pumping is stopped, allowing the filling to proceed as a normal fill. As a result, the dishwasher will have an improved clean ability and a shorter run time. Some conventional dishwashers, for example, fill an interior portion and then heat the water at approximately one degree per minute; for an incoming water temperature of eighty degrees, a delay of approximately forty minutes would result, or such a delay would prevent washing because of an elapsing of a time-out period.

The present methods may be used, for example, when a delayed start feature is implemented and the hot water pipes have cooled to room temperature. The hot water test, such as by method 120, may be performed before each fill operation of the dishwashing cycle, or for less than all the fill operations of a cycle. If the supply water is already hot, then the dishwasher quickly tests temperature and goes to the normal fill mode.

Indicator light 35 is illuminated during temperature testing of the supply water. A chosen timeout (e.g., 30 seconds, 1 minute, 5 minutes, etc.) can be set to any amount of time as an alternative to, or in addition to, the temperature of the incoming water. The timeout (e.g., step 103) may be used to prevent wasting water when the hot water line fails to ever reach the desired temperature, may be used as a redundant way to obviate the temperature sensing, for example when a temperature sensor has a limited lifetime, etc. Upon the occurrence of a specified event, such as reaching the temperature threshold or the timeout period, dishwasher 1 starts a normal fill. Indicator light 35 may be set to flash if the supply water temperature fails to reach a desired temperature or when such temperature exceeds an upper limit temperature. Such flashing indicator may be used for instructing a user to check the temperature setting on a hot water heater, to check water pipe insulation, etc. An optimum temperature is preferably used because too high a temperature may actually make some soils harder to remove.

Dishwashers 1 may include numeric display 34 for displaying the temperature of incoming water with two, three, or more digits, and for optionally displaying text messages, symbols, etc. For example, display 34 may be configured for simultaneously displaying the actual temperature and a text message such as “TEMP OK,” and/or error codes may also be displayed.

The antibacterial wash cycle for a given dishwasher may have a final rinse operation that includes heating the rinse water to one hundred sixty degrees Fahrenheit. When a dishwasher door is closed, vents are used that remain open to prevent excess pressure from building up inside the dishwasher. Typically, the final operation performed before drying the dishes is a pumping out of the rinse water. The subsequent drying cycle lasts approximately 25 minutes. The vents help assure that any dangerous level of steam is not present should a user open the door during this final rinse and drying period. The heat itself should also not present the danger of injury if the door should somehow be opened. However, a dishwasher may also include safety features to help reduce the possibility of injury to a user during these and other periods of high temperature operation.

A temperature sensor may be located inline with the hot water supply line, or may alternatively be located in the sump area of interior portion 22, such as at a location where the water exits the sump. This sump area placement of a temperature sensor may provide a more accurate representation of the temperature of the actual water being used for washing, but such sensor placement will likely result in more water being pumped out (higher water consumption) because the dishwasher tub and sump acts to cool the incoming water. Even with such higher water consumption, the net energy used by a dishwashing cycle may be less due to the reduction of the amount of heat to be added by a heating element of the dishwasher. In a further exemplary embodiment, a thermal device may be attached to the bottom of the dishwasher tub, such as at a location under the water path to the sump.

Some conventional dishwashers have mechanical timers. In such dishwashers, an automatic temperature control board of a type used in clothes washing machines may be adapted for testing the temperature of the incoming hot water supply. In such a case, a display of diagnostics may be impractical.

For dishwashers that connect to a water faucet such as a kitchen sink, the dishwasher manufacturers recommend running hot water at the sink before running the dishwasher. In addition, dishwashing detergent manufacturers also recommend running hot water at the sink before running the dishwasher. The use of the present methods avoids such a requirement. Some wash cycles can last fifteen to twenty-five minutes or more. In this time, hot water pipes can cool down. The degree to which the hot water pipes cool down depends on the distance between the dishwasher and the hot water heater. In addition, the environment the hot water pipes are exposed to (e.g., cold or cool basement, exterior walls) affects the degree of cooling of the hot water pipes. As a result of implementing the present methods, such conventional problems are addressed automatically.

An optional water savings switch (not shown) may be used for bypassing the water temperature testing for a given method. Similarly, a water temperature testing and pumping operation, as described herein, may be used for any operational portion of a chosen wash cycle. For example, the hot water supply test may be bypassed when it is conclusively determined that the incoming water temperature is too high or too low, and the user wishes to continue the cycle even though the detected temperature is out of the specified range. In such a case, for example, when a first fill operation performs a five minute pumping operation because the detected water temperature never reached a minimum, or when a user is informed that a temperature is over a maximum temperature and still wishes to proceed, a given method may include bypassing subsequent hot water testing and/or pumping operations in order to proceed with the wash without unnecessarily wasting water.

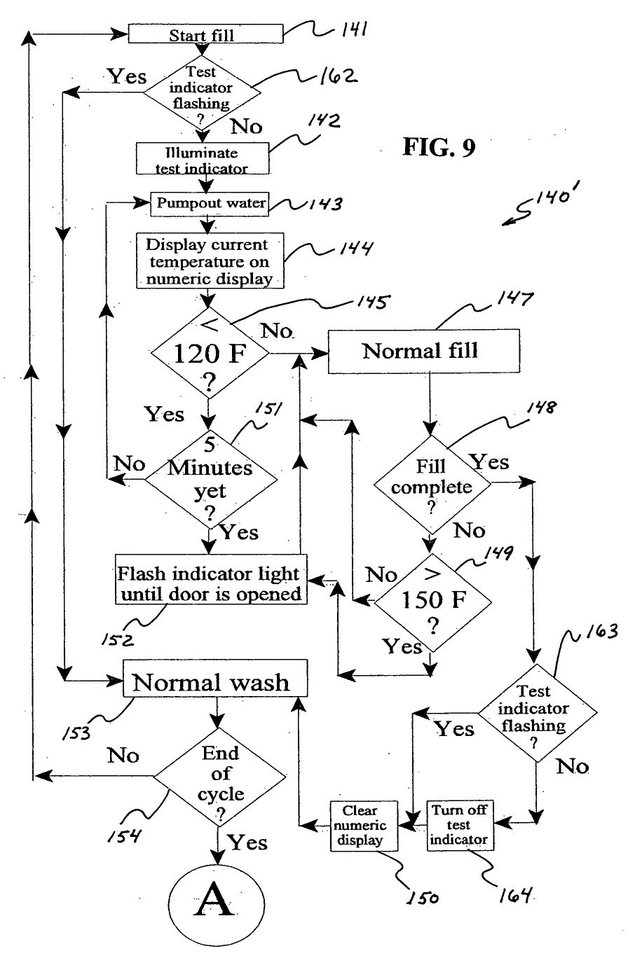

FIG. 9 shows an exemplary method 140′ that may be chosen as an alternative to a method 140 such as that shown in FIG. 8A. Similar operational steps are identified in the drawing by like reference characters. In FIG. 9, a method 140′ includes an initial step 162 where the status of the test indicator is checked to determine whether the indicator is in a flashing mode. If so, a previous hot water test and pumping operation may have resulted in a timeout for failure to reach the minimum temperature in a five minute period or such previous test and pumping operation may have resulted in a detected temperature over the maximum predetermined value; in such a case, method 140′ jumps to a normal fill operation at step 153. If not, method 140′ proceeds to perform steps 142-145 as described above for method 140. If step 145 determines that the detected temperature is not less than a low threshold temperature, then method 140′ proceeds to step 147 and proceeds in a manner described above for method 140. When a fill operation is determined to have been completed in step 148, a step 163 then determines whether test indicator 35 is flashing. If not, then a step 164 turns test indicator from full on to a full off state. Method 140′ thereby leaves test indicator 35 illuminated to inform the user that a fill is proceeding under acceptable temperature conditions. Method 140′ also maintains test indicator 35, or other indicator, in a flashing mode even during various operations, to inform the user that operations are continuing in out-of-range temperature condition, such as when a bypass of pumping is performed, etc.

While the principles of the invention have been shown and described in connection with specific embodiments, it is to be understood that such embodiments are by way of example and are not limiting. Consequently, variations and modifications commensurate with the above teachings, and with the skill and knowledge of the relevant art, are within the scope of the present invention. The embodiments described herein are intended to illustrate best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A method comprising:
inputting first water into a dishwasher in a first fill;
monitoring temperature of the first water;
pumping the first water out of the dishwasher until the temperature of the first water reaches a first predetermined temperature; and
then filling the dishwasher with second water in a second fill.

2. The method of claim 1 further comprising monitoring of first water temperature by obtaining a temperature from a fill tube.

3. The method of claim 2 further comprising displaying the fill tube temperature on an outer surface display of the dishwasher.

4. The method of claim 1 further comprising monitoring of first water temperature by obtaining a temperature from a sump area of the dishwasher.

5. The method of claim 4 further comprising displaying the sump area temperature on an outer surface display of the dishwasher.

6. The method of claim 1 further comprising stopping the pumping after a predetermined time.

7. The method of claim 6 further comprising adjusting the predetermined time based on a previous time required to reach the first predetermined temperature.

8. The method of claim 1 further comprising measuring a time from a starting of the inputting of first water until the reaching of the first predetermined temperature.

9. The method of claim 8 further comprising triggering an alarm when the measured time reaches a predetermined amount.

10. The method of claim 9 wherein the triggering of the alarm includes illuminating an indicator light.

11. A method comprising:
inputting water into a dishwasher;
pumping the water out of the dishwasher until a predetermined amount of time has elapsed; and
then filling the dishwasher with water.

12. The method of claim 11 wherein the method is repeated for each water fill of a dishwashing cycle.

13. A method comprising:
inputting water into a dishwasher;
monitoring a temperature of the water being input;
pumping the water out of the dishwasher;
if the monitored water temperature reaches a predetermined temperature, stopping the pumping, filling the dishwasher with the water being input, and performing a wash; and
if the monitored water temperature has not reached a predetermined temperature and a predetermined time has elapsed, stopping the pumping, filling the dishwasher with the water being input, and performing a wash.

14. The method of claim 13, further comprising repeating the method for each fill of a cycle being performed by the dishwasher.

15. The method of claim 13, further comprising, if the monitored water temperature has not reached a predetermined temperature and a predetermined time has elapsed during a first fill operation of a cycle, then bypassing the pumping for each subsequent fill operation of the cycle.

16. The method of claim 13, further comprising:
illuminating a test indicator during the pumping; and
turning off the test indicator during the filling and the performing of a wash.

17. The method of claim 13, further comprising flashing the test indicator when the monitored water temperature is below a first alarm temperature.

18. The method of claim 13, further comprising flashing the test indicator when the monitored water temperature is above a second alarm temperature.

19. The method of claim 18, further comprising disabling a performing of a wash if, during the filling, the monitored water temperature is above the second alarm temperature.

20. The method of claim 18 wherein the flashing of the test indicator continues until a dishwasher door is opened.

21. The method of claim 16 further comprising disabling the illuminator light when a door of the dishwasher is open.

22. A dishwasher, comprising:
a hot water inlet;
a temperature sensor for measuring a temperature of water being input via the hot water inlet;
a wash starter that initiates a dish washing when the water being input reaches a predetermined fill level; and
means for pumping the water being input out of the dishwasher, thereby preventing the water being input from reaching the fill level, until a specified criteria is met.

23. Apparatus of claim 22, wherein the specified criteria is the temperature reaching a predetermined value.

24. Apparatus of claim 22, wherein the specified criteria is the passage of a predetermined time.

25. Apparatus of claim 24 further comprising a mechanical timer operative to determine when the predetermined time has passed.1.
